(19) United States
(12) Patent Application Publication
(10) Pub. No.: US 2008/0147466 A1
(43) Pub. Date: Jun. 19, 2008

(54) Method of empowering owners of health-care resources

(76) Inventor: Anuthep Benja-Athon, New York, NY (US)

Correspondence Address: ANUTHEP BENJA-ATHON, 210 E 36th St., New York, NY, 10016, US

(21) Appl. No.: 12/072,097

(22) Filed: Feb. 25, 2008

Related U.S. Application Data
(63) Continuation-in-part of application No. 11/344,485, filed on Feb. 1, 2006.
Application No. 11/344,485 is a continuation-in-part of application No. 11/293,689, filed on Dec. 5, 2005.
Application No. 11/293,689 is a continuation-in-part of application No. 11/114,763, filed on Apr. 27, 2005.

(51) Int. Cl. G06Q 10/00; G06Q 20/00; G06Q 30/00

(52) U.S. Cl. 705/7; 705/30; 705/40

(57) ABSTRACT

A system of distributing and accounting funds, disbursements and credits of the health-care buyers, consumers and providers wherein the buyers and consumers pay the providers for the medical services and surgical services provided wherein the consumers, buyers and providers and the data and information on the services generated by the providers and are inputted into the computers servers and the computer programs in a network or networks of computers and servers mutually benefit them.

This application is a continuation-in-part of Ser. No. 11/344,485 entitled Physicians-patients-health-care-buyers accounting system filed Feb. 1, 2006, a continuation-in-part of Ser. No. 11/293,689 entitled System of conserving health-care buyers' resources and a continuation-in-part of Ser. No. 11/114,763 entitled A System of Influencing Health-Care Utilizations filed Apr. 27, 2005 which are pending.

### FIELD OF INVENTION

A system of controlling health-care resources by physicians, buyers and consumers.

### BACKGROUND OF THE INVENTION

One of the fundamental causes of the weakness of the American economy, lower standard of living, loss of jobs to overseas, escalating health-care costs, more than 40 million uninsured Americans, stress afflicting most Americans and higher morbidity and losses of lives due to supra is the high costs of doing business and wastes in America attributable to the hundreds of billions of dollars of waste per annum in the current 2-trillion-dollars-per-annum American health-care industry. In addition, just on the mundane paper and clerical works alone physicians are compelled to engage and do—unrelated to patient care—each day amount to a waste of more than 110 billion dollars each year which was not accounted in said escalating 2 trillion dollars.

The one and only solution to the above crises and dilemmas is provided by the innovations in the pending patent applications including the present invention of the present patent applicant and his co-applicants. In fact, this present invention alone results in the elimination of said 110 billion dollars of waste and, in addition, the social, economic, tangible and intangible benefits from this tangible benefit alone is much, much greater than said amount. The much-improved quality of American health-care and America will be more glorious can only be achieved with said innovations.

### SUMMARY OF THE INVENTION

A method of distributing and accounting funds, disbursements, payments, debits, credits, revenues and balances of the health-care buyers, health-care consumers and health-care providers and said buyers among the accounts of said buyers, consumers and providers wherein said buyers and consumers pay said providers for the medical services and surgical services provided by said providers in a network or networks of computers and servers wherein said health-care consumers, health-care buyers and health-care providers and the data and information on said services generated by said providers and are inputted into said computers and/or servers and their resources, funds and revenues, the computer programs and the system described infra mutually benefit said parties and entities.

### DESCRIPTION OF PREFERRED EMBODIMENTS

The present invention provides a system and a method of dispensing and accounting the health-care funds and fund disbursements from the accounts comprising the funds of the health-care buyers and health-care consumers and the crediting and accounting of the revenues derived from said disbursements in the accounts of the health-care providers in a network or networks of computers and servers wherein health-care buyers and consumers pay said providers for the medical and surgical services provided to said consumers by said providers wherein said funds originate from said buyers and consumers and are credited entered into said accounts of said buyers and consumers, wherein the transfers of funds among said accounts and the accounting of the funds, disbursements and balances of said funds of said buyers and consumers and the crediting and accounting of the credits and revenues in said accounts of said providers are instantly effected by the generations and inputs of the data and information on the medical and surgical services provided to said consumers by said providers in said network or networks of computers and servers, wherein individual monetary values are assigned to individual medical services and individual surgical services representing charges for individual medical and surgical services and monetary compensations for said providers for the medical and surgical services provided to said consumers, wherein the costs of operating the providers' practices and the reductions of the costs of practices as the consequences of the implementations of a means for reducing the costs of operating practices including a means for eliminating certain types of costs of operating practices and a means for reducing revenue losses including a means for eliminating certain types of revenue losses are entered and stored in the electronic database or databases and said data are computed to produce the adjusted payments or fees representing individual adjusted charges for individual medical services and individual surgical services rendered to the consumers by the providers which are entered and stored in the electronic database or databases, wherein data representing individual health-care buyers' funds are entered into said accounts and are entered into and stored in the electronic database or databases, wherein disbursements and payments of charges for said medical and surgical services to said providers are subtracted from said funds in said accounts and the disbursements, itemized payments for said services and balances in said accounts are stored in the database or databases and are displayed to said buyers and consumers and the itemized payments credited to physicians' accounts are stored in the database or databases and are displayed to the physicians.

Said individual medical and individual surgical services provided by physicians and are payable by health-care buyers and health-care consumers to said physicians are such as, but not limited to, physicians' Evaluation comprising items such as, but not limited to, consultations, visits, assessments, examinations, Laboratory, such as, but not limited to, CTScan, MRI, x-ray, electrodiagnosis, organ, blood and skin tests, Medications, Procedures, Treatments and Surgeries. Individual monetary values or fees are assigned to individual medical services and individual surgical services representing charges for individual medical and surgical services and monetary compensations for said providers for the medical and surgical services provided to said consumers. For example, a complex consultation by a physician may be assigned a value of $300 and a MMR vaccination by a pediatrician may be assigned a value of $60, etc. The database or databases comprising of said individual medical and individual surgical services for about 80 medical and surgical specialties are generated and stored in the database or databases and said data and information are constantly updated.

Physicians practicing in different localities, regions and locations in America have different costs of practices. Moreover, diverse medical and surgical practices, fields or specialties have different costs of practices such as, but not limited to, rents, various insurance premiums, overheads, staff and professional assistants. The present invention provides the accounts for said differences and related by allowing said physicians to provides the data on said issues and matters such as, but not limited to, the uses of the physicians' Internal Revenue Service income reports, various benefits and compensations, physicians' practices and records of salaries, wages, compensations and payments for staff and enterprises supporting the physicians' practices, revenues, expenses, earnings, compensations, expenses, overheads relating to the practices by entries the database or databases described herein.

By the innovative virtue—method and system described herein—the present invention provides the means of reducing the costs of operating practices including a means for eliminating certain types of costs of operating providers' practices and a means for reducing revenue losses including a means for eliminating certain types of revenue losses comprises the reductions and/or eliminations of the certain types of administrative and overhead costs, interferences by other parties not buyers, consumers and providers in the claims infra such as, but not limited to, the costs of billings, collections, overheads including, but not limited to, salaries, wages, compensations and payments for staff and companies supporting the providers' practices and related, costs of obtaining insurance permissions to treat and/or care for patients, loss revenues due to insurance's impositions of their “usual and customary charges” and rejections or denials of payments for services infra, the costs of disputes with insurance and appeal processes, loss revenues such as uncollectibles, unpaid charges and misses, costs of auditing billings and account receivables, time loss pertaining to and pursuing supra, costs of physicians' mundane clerical and administrative works and related. Said saving of hundreds of billions of dollars as described supra are passed on to said buyers and consumers as described supra.

The instant transfers of funds among said accounts and the instantly accounting of the funds, disbursements and balances of said funds of said buyers and consumers and the crediting and accounting of the credits and revenues in said accounts of said providers are instantly effected by the generations of the data and information on the medical and surgical services provided infra to said consumers by said providers and the inputs of said data and information in said network or networks of computers and servers. In other words, the computer programs infra of the present patent applicant—instantly after the data and information infra were generated by said providers and are submitted in said network or networks of computers and servers instantly caused the transfers—debits or deductions and credits—of funds among said accounts and instantly accounting for all funds, disbursements, payments, credits, revenues, balances which are instantly computed, stored in database or databases, and appropriately displayed to said buyers, consumers and buyers. Said events or phenomena—in a common computer—using Microsoft Corporation operating system, SQL and Internet Explorer and browser and php—occur in less than a few seconds after said data and information infra were generated and submitted at the push of the Enter key or the equivalence.

The innovative computer programs created and used by the present patent applicant are based on the commercially available computer software (plural), programs and computer languages such as, but not limited to, those made and sold by Microsoft Corporation such as, but not limited to, SQL such as, but not limited to Microsoft SQL, MySQL and the like, Internet Explorer, browsers, Visual Studio and .Net and the like and their databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA and their derivatives and related.

It is understood that patients are or can be health-care consumers and health-care buyers and employers, companies, corporations and governments are health-care buyers although employers are or can be patients. Health-care providers are physicians and other people who provided health and health-related services to people.

The terms health-care, health care and healthcare have the same meaning and application herein. Health-care resources, funds, payments, fees, charges, etc. used herein are such as, but not limited to, dollars and cents and other foreign currencies and instruments of payment.

Although the preferred embodiments have been described, it will be appreciated by those skilled in the art that variations, additions and adaptations to the present invention can be made without departing from the spirit of the invention and the scope of the claims.

1. A method of dispensing and accounting health-care funds and fund disbursements from the accounts comprising the funds of the health-care buyers and health-care consumers and the crediting and accounting the revenues derived from said disbursements in the accounts of the health-care providers in a network or networks of computers and servers wherein health-care buyers and consumers pay said providers from said funds for the medical and surgical services provided to said consumers by said providers wherein said funds are originated from said buyers and consumers and are credited into said accounts of said buyers and consumers, wherein the transfers of funds among said accounts and accounts of the funds, disbursements, deductions and balances of said funds of said buyers and consumers and the crediting and accounts of the credits and revenues in said accounts of said providers are effected by the generations and inputs of the data and information on the medical services and surgical services provided to said consumers by said providers, wherein individual monetary values are assigned to individual medical services and individual surgical services representing charges for individual medical and surgical services and monetary compensations for said providers for the medical and surgical services provided to said consumers, wherein the costs of operating the providers' practices and the reductions of the costs of practices as the consequences of the implementations of a means for reducing the costs of operating practices and a means for reducing revenue losses are entered and stored in the electronic database or databases and said data are computed to produce the adjusted payments or fees representing individual adjusted charges for individual medical services and individual surgical services rendered to the consumers by the providers which are entered and stored in the electronic database or databases, wherein data representing individual health-care buyers' funds are entered into and credited to said accounts and are entered into and stored in the electronic database or databases, wherein disbursements and payments of said charges are subtracted from said funds in said accounts and the disbursements, itemized payments for said services and balances in said accounts are stored in the database or databases and are displayed to said buyers and consumers and the itemized payments credited to and revenues in said physicians' accounts are stored in the database or databases and are displayed to the physicians comprises:
a process of using data and information on medical services and surgical services provided to said consumers by said providers generated by said providers;
a process of creating accounts for providers;
a process of creating accounts for health-care buyers;
a process of creating accounts for health-care consumers;
a process of crediting accounts for health-care buyers;
a process of crediting accounts for health-care consumers;
a process of crediting accounts of physicians;
a process of implementing a means for reducing the costs of operating practices;
a process of implementing a means for reducing revenue losses;
a means for reducing the costs of operating practices;
a means for reducing revenue losses of said providers;
a process of transferring funds among said accounts;
a process of using data and information on medical services and surgical services provided to the said consumers by said providers for effecting the transfers of funds among said accounts of said buyers, consumers and providers;
a process of distributing disbursements into health-care consumers' accounts from health-care buyers' accounts;
a process of disbursing disbursements from said buyers' accounts;
a process of disbursing payments from said buyers' accounts;
a process of deducting disbursements from said buyers' accounts;
a process of disbursing payments from said consumers' accounts;
a process of deducting disbursements from said consumers' accounts;
a process of crediting payments to the providers' accounts from buyers' accounts;
a process of crediting payments to said providers' accounts from said consumers' accounts;
a process of displaying itemized payments of said services to said consumers;
a process of displaying itemized payments to said providers;
a process of displaying disbursements, payments, deductions, revenues, credits and balances; and
a process of relating said processes.

2. The method according to claim 1 wherein said means for reducing the costs of operating practices comprises the reductions of the administrative costs of said providers.

3. The method according to claim 1 wherein said means for reducing the costs of operating practices comprises the transfers of funds among said accounts in said network or networks of computer and servers.

4. The method according to claim 1 wherein said means for reducing the costs of operating practices comprises the accounting of the funds, disbursements, deductions and balances of said funds of said buyers and consumers.

5. The method according to claim 1 wherein said means for reducing the costs of operating practices comprises the crediting and accounting of the credits and revenues in said accounts of said providers.

6. The method according to claim 1 wherein said means for reducing the costs of operating practices comprises the data and information on medical services and surgical services provided to said consumers by said providers generated by said providers

7. The method according to claim 1 wherein said means for reducing the costs of operating practices comprises the generations of the data and information on the medical services and surgical services provided to said consumers by said providers.

8. The method according to claim 1 wherein said means for reducing the costs of operating practices comprises the inputs of the data and information on the medical services and surgical services provided to said consumers by said providers into said network or networks of computer and servers.

9. The method according to claim 1 wherein said means for reducing the costs of operating practices comprises the reductions of the overheads of said providers' practices.

10. The method according to claim 1 wherein said means for reducing the costs of operating practices comprises the reductions of the interferences in said providers' practices.

11. The method according to claim 1 wherein said means for reducing revenue losses of said providers comprises the payments by said buyers for the medical and surgical services provided by the health-care providers in said network or networks of computers and servers.

12. The method according to claim 1 wherein said means for reducing revenue losses of said providers comprises the payments by said consumers for the medical and surgical services provided by the health-care providers in said network or networks of computers and servers.

13. The method according to claim 1 wherein said means for reducing revenue losses of said providers comprises the dispensations of payments for said services from said accounts of buyers to the accounts of the health-care providers.

14. A method of using data and information on medical services and surgical services provided to the health-care consumers by the health-care providers generated by said providers and are in a network or networks of computers and servers for effecting the transfers of funds among the accounts of health-care buyers, health-care consumers and health-care providers and for accounting for the disbursements of health-care buyers' and health-care consumers' funds and revenues of the health-care providers in a network or networks of computers and servers wherein health-care buyers and consumers pay said providers from said funds for the medical and surgical services provided to said consumers by said providers wherein said funds are originated from said buyers and consumers and are credited into said accounts of said buyers and consumers, wherein the transfers of funds among said accounts and accounts of the funds, disbursements, deductions and balances of said funds of said buyers and consumers and the crediting and accounts of the credits and revenues in said accounts of said providers are effected by the generations of said data and information by said providers which are inputted in said network or networks of computers and servers, wherein individual monetary values are assigned to individual medical services and individual surgical services representing charges for individual medical and surgical services and monetary compensations for said providers for the medical and surgical services provided to said consumers, wherein the costs of operating the providers' practices and the reductions of the costs of practices as the consequences of the implementations of a means for reducing the costs of operating practices and a means for reducing revenue losses are entered and stored in the electronic database or databases and said data are computed to produce the adjusted payments or fees representing individual adjusted charges for individual medical services and individual surgical services rendered to the consumers by the providers which are entered and stored in the electronic database or databases, wherein data representing individual health-care buyers' funds are entered into and credited to said accounts and are entered into and stored in the electronic database or databases, wherein disbursements and payments of said charges are subtracted from said funds in said accounts and the disbursements, itemized payments for said services and balances in said accounts are stored in the database or databases and are displayed to said buyers and consumers and the itemized payments credited to and revenues in said physicians' accounts are stored in the database or databases and are displayed to the physicians comprises:
a process of using data and information on medical services and surgical services provided to said consumers by said providers generated by said providers;
a process of creating accounts for providers;
a process of creating accounts for health-care buyers;
a process of creating accounts for health-care consumers;
a process of crediting accounts for health-care buyers;
a process of crediting accounts for health-care consumers;
a process of crediting accounts of physicians;
a process of implementing a means for reducing the costs of operating practices;
a process of implementing a means for reducing revenue losses;
a means for reducing the costs of operating practices;
a means for reducing revenue losses of said providers;
a process of transferring funds among said accounts;
a process of using data and information on medical services and surgical services provided to the said consumers by said providers for effecting the transfers of funds among said accounts of said buyers, consumers and providers;
a process of distributing disbursements into health-care consumers' accounts from health-care buyers' accounts;
a process of disbursing disbursements from said buyers' accounts;
a process of disbursing payments from said buyers' accounts;
a process of deducting disbursements from said buyers' accounts;
a process of disbursing payments from said consumers' accounts;
a process of deducting disbursements from said consumers' accounts;
a process of crediting payments to the providers' accounts from buyers' accounts;
a process of crediting payments to said providers' accounts from said consumers' accounts;
a process of displaying itemized payments of said services to said consumers;
a process of displaying itemized payments to said providers;
a process of displaying disbursements, payments, deductions, revenues, credits and balances; and
a process of relating said processes.

15. A method of using data and information on medical services and surgical services provided to the health-care consumers by the health-care providers generated by said providers for effecting the reductions of the costs of practices of said providers wherein the costs of operating the providers' practices and the reductions of the costs of practices as the consequences of the implementations of a means for reducing the costs of operating practices and a means for reducing revenue losses are entered and stored in the electronic database or databases and said data are computed to produce the adjusted payments or fees representing individual adjusted charges for individual medical services and individual surgical services rendered to the consumers by the providers which are entered and stored in the electronic database or databases wherein individual monetary values are assigned to individual medical services and individual surgical services representing charges for individual medical and surgical services and monetary compensations for said providers for the medical and surgical services provided to said consumers, wherein the costs of operating the providers' practices and the reductions of the costs of practices as the consequences of the implementations of a means for reducing the costs of operating practices and a means for reducing revenue losses are entered and stored in the electronic database or databases and said data are computed to produce the adjusted payments or fees representing individual adjusted charges for medical services and surgical services rendered to the consumers by the providers which are entered and stored in the electronic database or databases comprises:
a process of using data and information on medical services and surgical services provided to said consumers by said providers to produce said means for reducing the costs of operating practices of said providers;
a process of using data and information on medical services and surgical services provided to said consumers by said providers to produce said means for reducing revenue losses of said providers;
a process of implementing a means for reducing the costs of operating practices of said providers;
a process of implementing a means for reducing revenue losses of said providers;
a means for reducing the costs of operating practices of said providers; and
a means for reducing revenue losses of said providers of said providers.
